(19) United States
(12) Patent Application Publication
(10) Pub. No.: US 2015/0024360 A1
(43) Pub. Date: Jan. 22, 2015

(54) METHOD AND SYSTEM FOR GAINING BALANCED HEALTH AND FITNESS REGIME

(71) Applicant: RECOAPP OY, JYVÄSKYLÄ (FI)

(72) Inventor: Markus Mäntynen, Jyvaskyla (FI)

(21) Appl. No.: 14/383,354

(22) PCT Filed: Feb. 18, 2013
(86) PCT No.: PCT/FI2013/050186

§ 371 Date: Sep. 5, 2014

Related U.S. Application Data
(60) Provisional application No. 61/608,866, filed on Mar. 9, 2012.

(51) Int. Cl. A63B 24/00; G09B 5/02; G06F 19/00

(52) U.S. Cl. CPC A63B 24/0062; G06F 19/3475; G09B 5/02
USPC 434/257

(57) ABSTRACT

A system, method and computer program product for gaining a balanced health and fitness regime, including a user interface configured for receiving and displaying information regarding muscle recovery times of workouts of a user; and the user interface is configured in a form of a human body with selectable muscle portions thereon for displaying respective information regarding the recovery times of the workouts of a user.

### CROSS REFERENCE TO RELATED DOCUMENTS

The present invention claims benefit of priority to U.S. Provisional Patent Application Ser. No. 61/608,866 of Veli Markus MANTYNEN, entitled “METHOD AND SYSTEM FOR GAINING BALANCED HEALTH AND FITNESS REGIME,” filed on Mar. 9, 2012, the entire disclosure of which is hereby incorporated by reference herein.

### BACKGROUND OF THE INVENTION

1. Field of the Invention

The present invention generally relates to physical exercise systems and methods, and more particularly to a method and system for gaining information for a balanced health and fitness regime via body parameters and a recovery time of a workout, for achieving increased health, fitness, and the like, and a state known as supercompensation in the field of sports and exercise science, and the like.

2. Discussion of the Background

Physical exercise systems and methods have been employed for numerous years for providing fitness regimes, and the like. However, the present physical exercise systems and methods typically do not provide means (e.g., from the field of sports and exercise psychology) for gaining information for a balanced health and fitness regime via body parameters and a recovery time of a workout (e.g., during microcycles in sports periodization), for achieving increased health, fitness, and the like, and a state known as supercompensation in the field of sports and exercise science, and the like.

### SUMMARY OF THE INVENTION

Therefore, there is a need for a cost effective method and system (e.g., from the field of sports and exercise psychology) for measuring balanced health and fitness regime that address the above and other problems with workout related muscle recovery times, providing improved health and fitness or state known as supercompensation, avoiding symptoms of overtraining, improving hormonal response and providing information for users for gaining and sustaining balanced health and fitness regime. The above and other needs are addressed by embodiments of the present invention, which provide a system and method for gaining balanced health and fitness regime, including monitoring tool for exercisers to analyze, adjust and achieve individual recovery times (e.g., during microcycles in sports periodization). In sports periodization, a microcycle can include a weekly training routine, ranging normally from 2-10 days, typically a week, and the like. Advantageously, this method can guide users in achieving an ideal time for a next workout, known as a state of supercompensation and avoid symptoms of overtraining. Accordingly, in one aspect, a system and method for monitoring overall status of real time muscle recovery process and recent workouts is provided. The system and method also include post workout and real-time methods for entering workouts. In an illustrative embodiment, a data analyzer, used for storing and displaying workouts with individual recovery times (e.g., preset recovery times, realized recovery times) is provided. The system and method also include storage and information for achieving balanced health and fitness regime via teaching individuals to learn supercompensation (e.g., recovery) times, and the like. In a further illustrative embodiment, the data analyzer can be used for storing, displaying, and setting alarms for related workout routines (e.g., mesocycles), and the like. In sports periodization, a mesocycle can include a training routine or method, a time period a trainee keeps the routine the same for a certain period of time (e.g., 2-8 weeks), and the like. Advantageously, the system and method teaches individuals to optimize muscle adaptation, and the like, to avoid the state known as plateau, and the like.

Accordingly, in illustrative aspects of the present invention there is provided a system, method and computer program product for gaining a balanced health and fitness regime, including a user interface configured for receiving and displaying information regarding muscle recovery times of workouts of a user. The user interface can be configured in a form of a human body with selectable muscle portions thereon for displaying respective information regarding the recovery times of the workouts of a user.

The system, method and computer program product also can include the user interface configured for receiving workout related information from the user; the user interface configured for enabling the user to learn workout recovery times, including microcycles and mesocycles; the user interface configured for enabling the user to reach a hypertrophy state; the user interface configured for enabling the user to see a muscle recovery process; the user interface configured for enabling the user to optimize a muscle adaptation state; and the user interface configured for enabling the user to avoid a plateau state.

The system, method and computer program product also can include the user interface configured for enabling the user to input recovery times, including a capability for individual calibration, enabling the user to reach a supercompensation state and avoid symptoms of overtraining.

The system, method and computer program product also can include the user interface configured for enabling the user to fine tune recovery times; the user interface configured for enabling the user to analyze preset and realized recovery times; and the user interface configured enabling the user to compare recovery times with workout related information.

The system, method and computer program product also can include the user interface configured for analyzing a workout workload, including workout intensity and workout volume of a workout.

Still other aspects, features, and advantages of the present invention are readily apparent from the following detailed description, simply by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative block diagram for describing a health and fitness regime system and method, according to an illustrative embodiment of the present invention;

FIGS. 2A-2B are an illustrative flow chart for describing processes performed by the illustrative health and fitness regime system and method;

FIG. 3 is an illustrative view of a muscle recovery process screen of the flow chart of FIGS. 2A-2B;

FIG. 4 is an illustrative view of a workout builder screen of the flow chart of FIGS. 2A-2B;

FIG. 5 is an illustrative view of a general parameters screen of the flow chart of FIGS. 2A-2B;

FIG. 6 is an illustrative view of a workload screen of the flow chart of FIGS. 2A-2B;

FIG. 7 is an illustrative view of a calibrate screen of the flow chart of FIGS. 2A-2B;

FIG. 8 is an illustrative view of a fine tune screen of the flow chart of FIGS. 2A-2B;

FIG. 9 is an illustrative view of a recent workout screen of the flow chart of FIGS. 2A-2B; and

FIG. 10 is an illustrative computer system, which may be programmed to perform one or more of the processes described with respect to FIGS. 1-9.

### DETAILED DESCRIPTION OF THE PREFERRED EMBODIMENTS

The present invention includes recognition that people are seeking ways for a balanced health and fitness regime, and the like. For example, there are over 45 million registered gym users in fitness clubs throughout the United States. The popularity of fitness will only increase in the future. However, as health and fitness gains more popularity, so do the number of people seeking various types of methods for analyzing, measuring, and the like, their health and fitness regime.

The present invention further includes recognition that proper recovery time from a workout is a factor for achieving a balanced health and fitness regime. Traditionally, muscle recovery time (e.g., rest) has been one of the factors in physical exercise. Other factors include training, diet, and the like. A question often asked is therefore, how hard should someone be pushing themselves to achieve peak levels of physical output? Maybe exercisers are pushing too hard or maybe not hard enough.

In sports science, an optimal post-training period is called supercompensation. Another question often asked is how can someone learn an optimal resting period after a workout to gain a balanced health and fitness regime? In addition, there are other parameters for exercisers to take into consideration, for example, such as a total workload of a workout, stress, sleep, nutrition (e.g., quality plus quantity), workout routine method, type and length of a particular exercise, and the like.

The term muscle hypertrophy, in common language, is known as increased muscle mass and cross-sectional area of a muscle. This occurs, for example, when a muscle is stressed above minimum threshold intensity. This leads the muscle to adapt and improve its function. Muscle adaptation is a term used in sports and exercise science for describing how exercised muscles can improve their performance through neural and hypertrophic adaptations, and the like. For example, when progress of a workout hits an invisible wall or stall, this is called as a plateau. According to researchers, it is important to ensure continuous muscle adaptation for exercised muscles, in order to optimize workout results. There are known techniques for ensuring muscle adaptation, such progressive overload, periodization, and the like. In sports periodization, a microcycle can include a weekly training routine, ranging normally from 2-10 days, typically a week, and the like. A mesocycle can include a workout routine or method, including a time period a trainee keeps the routine same for a certain period of time (e.g., 2-8 weeks), and the like. The term repetition maximum (RM), for example, is the maximum number of repetitions a person estimates that the person is most likely to achieve during an exercise.

Anaerobic activity, which is relatively short timed (e.g., approximately under 45-60 minutes), high intense training, combined with recovery parameters, such as rest, nutrition (e.g., quality plus quantity), stress, sleep, and the like, are prerequisites to optimize the production of natural body hormones, such as testosterone, and the like. For example, positive effects of increased testosterone levels include sharpened memory and concentration, better sex drive, increased energy levels and muscle mass, and the like.

However, there may only be a few services available for measuring recovery times, and such services can be expensive, complex, and hard to understand, and can require external measuring units, and the like. Prices for such methods and services can generally be calculated in hundreds of dollars.

Accordingly, the present inventions provides a cost effective system and method for gaining a balanced health and fitness regime on a computer system, gym exercise equipment, a portable device, and the like, and includes a method and system that can be used to teach users to learn to listen to their bodies, advantageously, enabling the users to learn their individual recovery times for a workout, and the like. Thus a method, system and software for enabling users to gain a balanced health and fitness regime is described, allowing for receiving information from users, providing users with ways to analyze, adjust and achieve proper recovery times, enabling users to achieve a state known as supercompensation and avoid symptoms of overtraining, enabling users to optimize the state of muscle adaptation and to avoid the state of plateau, as known in the field of sports and exercise science, enabling users to maximize the production of natural body hormones, such as testosterone, and the like, via proper workout intensity and other recovery related parameters, enabling the state known as hypertrophy, and the like, advantageously, enabling users to see a real time muscle recovery process, and the like.

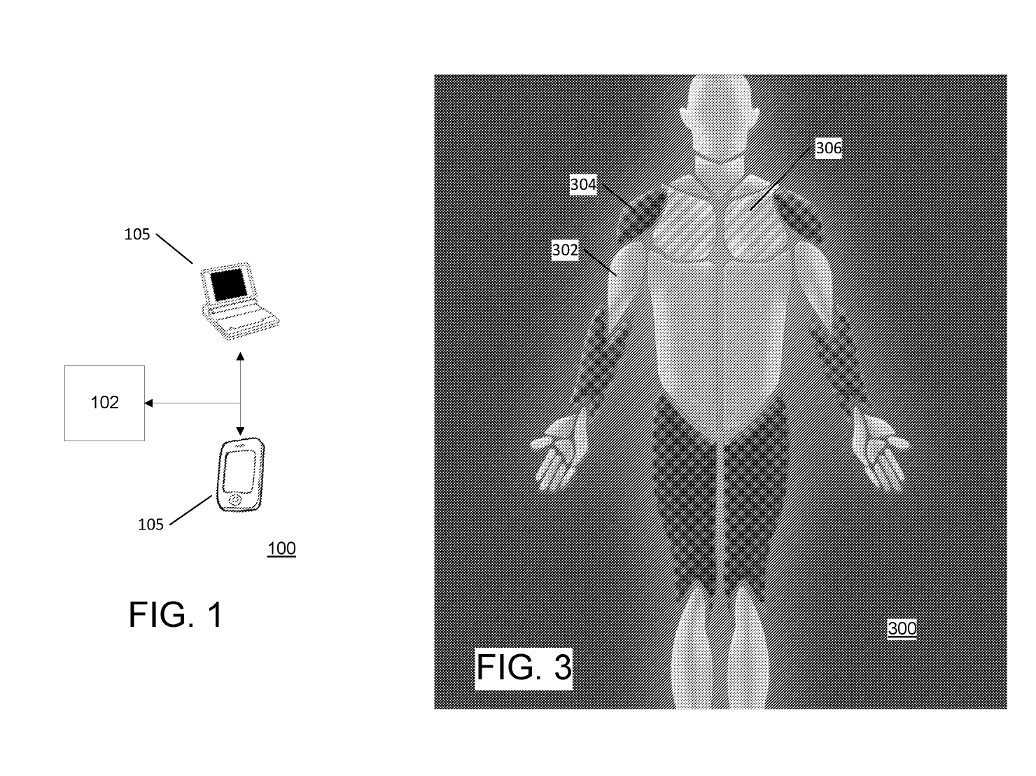

Referring now to the drawings, wherein like reference numerals designate identical or corresponding parts throughout the several views, and more particularly to FIG. 1 thereof, there is illustrated a system and method 100 for implementing a health and fitness regime, according to an illustrative embodiment. In FIG. 1, generally, the health and fitness regime system 100 provides a user via devices 105 (e.g., smart phones, PDAs, laptop computers, general purpose computers, etc.) with a method and interface to track, analyze, learn, and the like, post exercise recovery (e.g., supercompensation) times, monitor other recovery related body functions, and the like. Moreover, the health and fitness regime system 100 provides the user with a method and interface to optimize the state known as muscle adaptation and to avoid the state known as plateau. The system 100 includes, for example, data analyzer 102, as an illustrative user interface on the device 105.

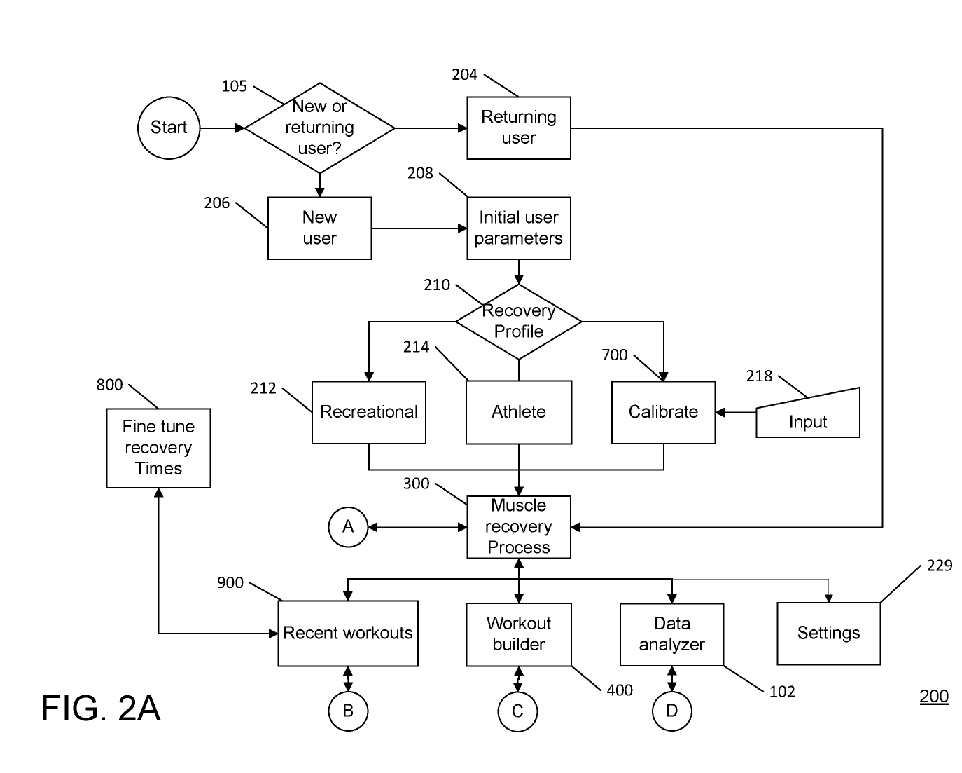

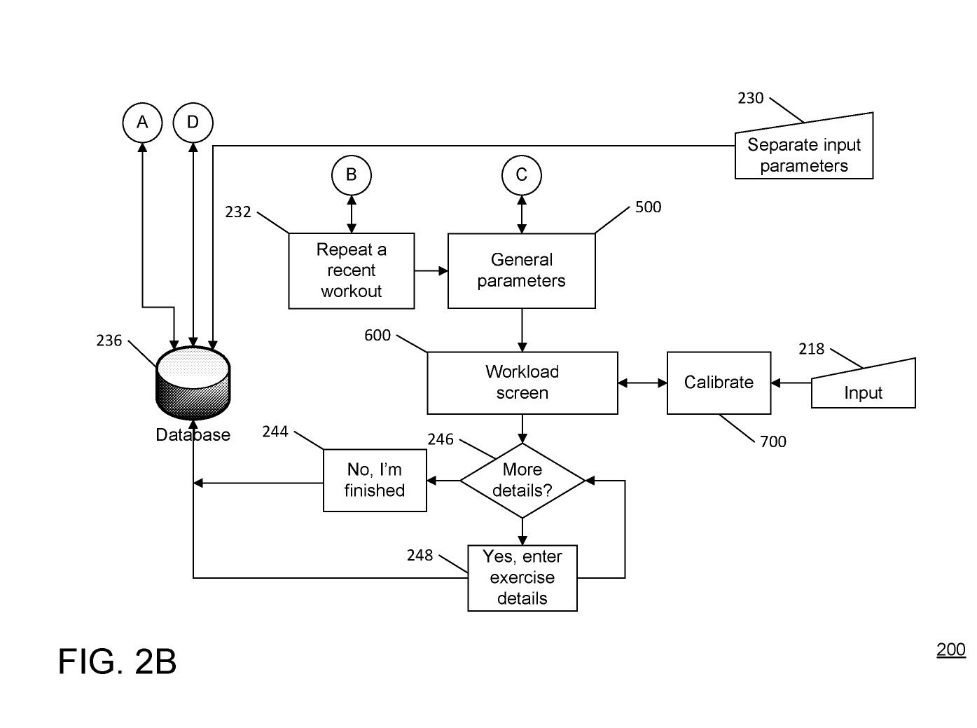

FIGS. 2A-2B are a flow chart 200 for describing processes of the illustrative health and fitness regime system and method. In FIGS. 2A-2B, the flowchart 200 includes end user computing interactions, and the like. A database 236 is provided and can include, for example, an SQL database, and the like, used to store various types of information including, for example, information about body functions, such stress, nutrition, sleep, total workload of a workout, utilization of recovery beverages or snacks, detailed workout data, such as a specified exercise name, workout routine methods, recovery (e.g., supercompensation) times, other workout related data, such as number of sets, repetitions, weight, notes, workout time and duration, rest between sets, and the like. Information areas 400, 500, and 600 for entering new workouts and related information via steps 244-248 can be implemented via post workout or real-time workout methods. The post workout method is an easy-to-use method and is suited for recreational users, and the like. The real-time method is more suited for athletes (e.g., competing in high intensity workouts), such as body builders, power lifters, Olympic weightlifters, Mixed Martial Arts (MMA) practitioners, CrossFit practitioners, and the like.

In a case of a new user, the user via the device 105 is directed through a setup wizard at steps 206-218, including terms of use of the system 100. Initial parameters entered via the setup wizard, for example, can include a user's height, weight (e.g., either metric or imperial units), date of birth (e.g., age), gender, and the like. The new user can choose a recovery profile at step 210. For example, the user can choose from preset profiles at steps 212 and 214 or can create their own custom recovery profile via a calibrate screen 700. Detailed descriptions for the recovery profiles 212-218 and the calibrate screen 700 are further described. Input parameters are entered at step 218 for the custom recovery profile for the user via the interactive calibration screen 700. After inputting the data for the setup wizard or in a case of a returning user at step 204, the user is directed to a muscle recovery process screen 300. The screen 300 can be used as a main view for the system 100 and can be used to display the overall status of a current muscle recovery process of a user on a human body used for displaying muscles from front and rear views, and the like. Via the interactive muscle recovery process screen 300, the user can access a workout builder screen 400, a recent workouts screen 900, the data analyzer 102, via settings entry step 229, and the like, at any time.

In the muscle recovery process screen 300, the user can access various settings via step 229, from which the user can manipulate the muscle recovery process screen 300 related functions, such as the recovery profile via step 210, and related values via steps 212-214 and the calibrate screen 700. The user can also change the way of sorting recent workouts (e.g., by recovery or by chronological order), change the method used for a new workout (e.g., post workout or real-time method), set custom repetition maximum (RM) values, set alarms for both workout routine methods and next available muscle or muscle groups to exercise (e.g., triggered by recovered muscles), control usage of indication arrows 606-608, and 814-816, as further described.

In addition, the user can disable certain features for streamlining the process for entering a new workout in information areas 500-600, and via steps 244-246, such as disabling time and workout duration inputs, and the like. The muscle recovery process screen 300, the recent workouts screen 900, the workout builder screen 400, the fine tune screen 800, and the data analyzer 102, are further described. Separate input parameters can be entered via step 230 and can be used for entering parameters that are not related to a workout, such as the user's weight, calorie intake and consumption, and the like.

The repeat a recent workout process via step 232 is accessible through the recent workouts screen 900. The interactive screen view 900 used for repeating a recent workout via step 232 is accessible, even when muscles of the user are not fully recovered, according to the interactive view of the muscle recovery process screen 300. Detailed descriptions for the general parameters process screen 500, the workload screen 600, the calibrate screen 700, and the repeat a recent workout process via step 232 are further described.

An interactive process for displaying more details via step 246 is used for creating a shortcut (e.g., for finishing the workout entering process) for the user when the user does not want to enter more details for a workout, such as specified information for an individual exercise, and the like. For example, if user decides not to enter more details via step 244, then the workout related data entered so far is stored in the database 236 and the user is redirected to the muscle recovery process screen 300, with the updated information from latest workout among the other recent workouts. If the user decides to enter more details via step 246, the user has opportunity to enter or select an individual name for a recent exercise, enter a number sets, repetitions, weight, repetition maximum, custom repetition maximum, workout method, rest between sets, workout notes, and the like.

After submitting the requested information, a loop via step 248 is used for entering further details for a recent exercise. This enables the user to enter various exercise details of a given workout, such as bench press, squat, dead lift, and the like, into a single workout. When the user is done entering the requested information, the loop of step 248 can be terminated via step 244, saving the workout related data, individual exercise information, and the like, in the database 236, completing the process.

FIG. 3 is an illustrative view of a muscle recovery process screen 300. The screen 300 can be used to display information for real time muscle recovery after physical exercise. In FIG. 3, the muscle recovery process screen 300 can include support for color vision deficiencies, for example, by presented information using patterns of stripes, and the like. In further illustrative embodiments, colors can also be used for such representations. For example, elements 302, 304 and 306 are used to illustrate various stages of muscle recovery status, and the like. The elements 302, 304 and 306 can be synchronized with a slider 608 of the workload screen 600, which indicates a total workload of a workout with adjacent colors, as further described. The element 304 can be indicated with a dark color (e.g., red) and cross striping used for illustrating an intense workload, for example, ranging from 66 to 100 percentage of a total workload of a workout. Thus, the element 304 can be used for indicating a recently exercised muscle with relatively high recovery times. The element 306, for example, can be used with an intermediate color (e.g., yellow) and single striping, for illustrating an intermediate muscle recovery process, for example, ranging from 33 to 65 percentage of a total workload of a workout. Thus, the element 306 can be used for indicating muscles that are soon-to-be-ready for a new workout and with relatively low recovery times. The element 302 can be indicated with a bright color (e.g., green) with no striping for indicating a muscle or certain muscles groups that are recovered and ready for a new exercise.

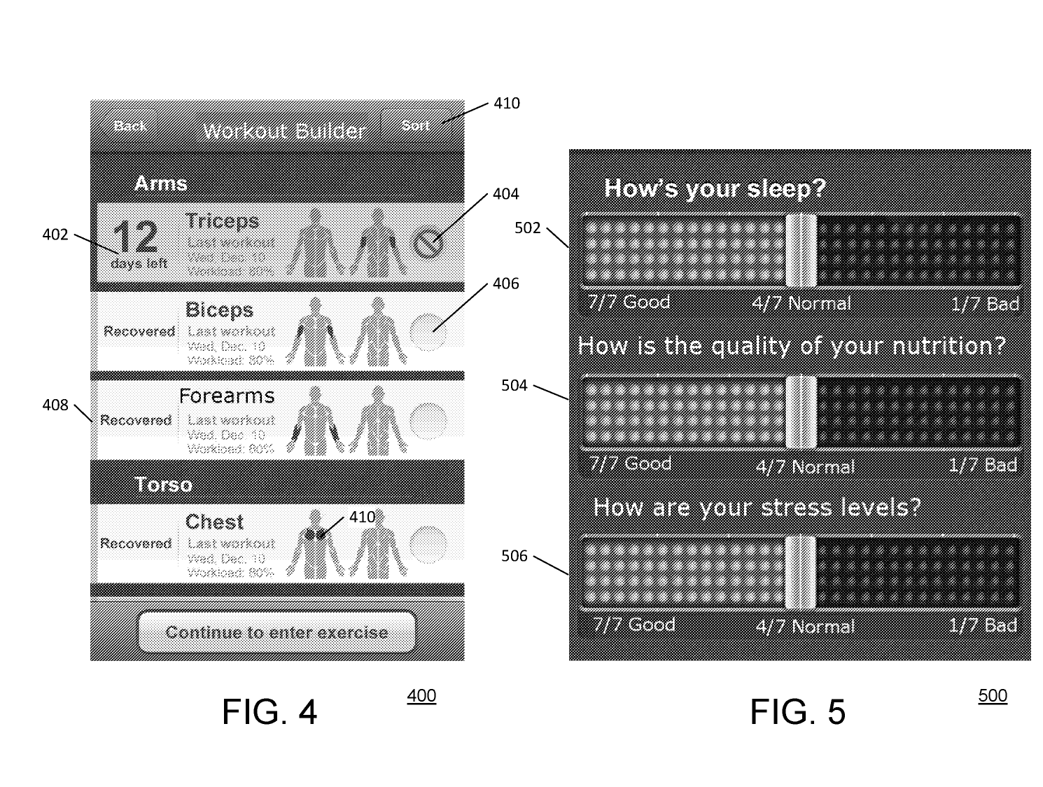

FIG. 4 is an illustrative view of a workout builder screen 400. The screen 400 can be used to list muscles or muscle groups that covers all areas of a human body (not shown). In FIG. 4, the illustrative screen 400 can be used to display information used for the real time muscle recovery process screen 300, and can be used to grant or deny the user access to build a new workout in accordance with selection buttons 406 or via denial signal 404. When the muscle recovery process is incomplete, the workout builder can reject the selection of a particular muscle or muscle group via the denial sign 404. When a muscle or muscle group are recovered and ready for a new workout, the selection button 406 can be activated. The recovery time left for a specific muscle is displayed in information section 402. Status area 408 can be include the color coded or striped status of a muscle recovery stage, as described with respect to elements 302, 304 and 306, and depending on a current muscle recovery stage of the muscle recovery process screen 300.

If a muscles or muscle group are recovered and the selection button 406 is activated, the user can bundle one or more muscles or muscle groups into a single workout. After storing the workout parameters by finishing the interaction via step 244, the recent workout and related muscles and workout parameters are stored in the database 236, and displayed to the user via the interactive screens, such as the muscle recovery process screen 300, the recent workouts screen 900, and via the data analyzer 102. In addition, a sort button 410 is provided allowing the user the ability to sort recovered muscles in chronological order, by recovery status, and the like.

FIG. 5 is an illustrative view of general parameters screen 500. Not all features are not shown in the illustrative view, and can further include duration of a workout, whether the user has taken a recovery drink or a snack after a workout, and the like. In FIG. 5, the illustrative view can be used for creating prerequisites and information for analyzing a health and fitness regime. For example, input sliders 502-506 can be provided and can be color coded and/or used with striping for supporting color vision deficiencies and provided supportive text information. In an illustrative embodiment, a green color can be used for indicating a good condition (e.g., one third of the bar on the left), a yellow color can be used for indicating a normal condition (e.g., one third of the bar on the middle), and a red color can be used for indicating a bad condition (e.g., one third of the bar on the right), and the like.

For example, quality of sleep can be entered via element 502, nutritional information can be entered via element 504, stress levels can be entered via element 507, and can be displayed as sliders on a 7-point scale, and the like. The entered information is stored in the database 236 and displayed to the 105 via the data analyzer 102 (e.g., via the recent workouts screen 900). Thus, the sliders 502-506 can be advantageous in helping the user to learn to listen to their central body parameters, thus enabling the user to see the overall status and trends of their body and other muscle recovery related progress via the data analyzer 102 (e.g., via the recent workouts screen 900).

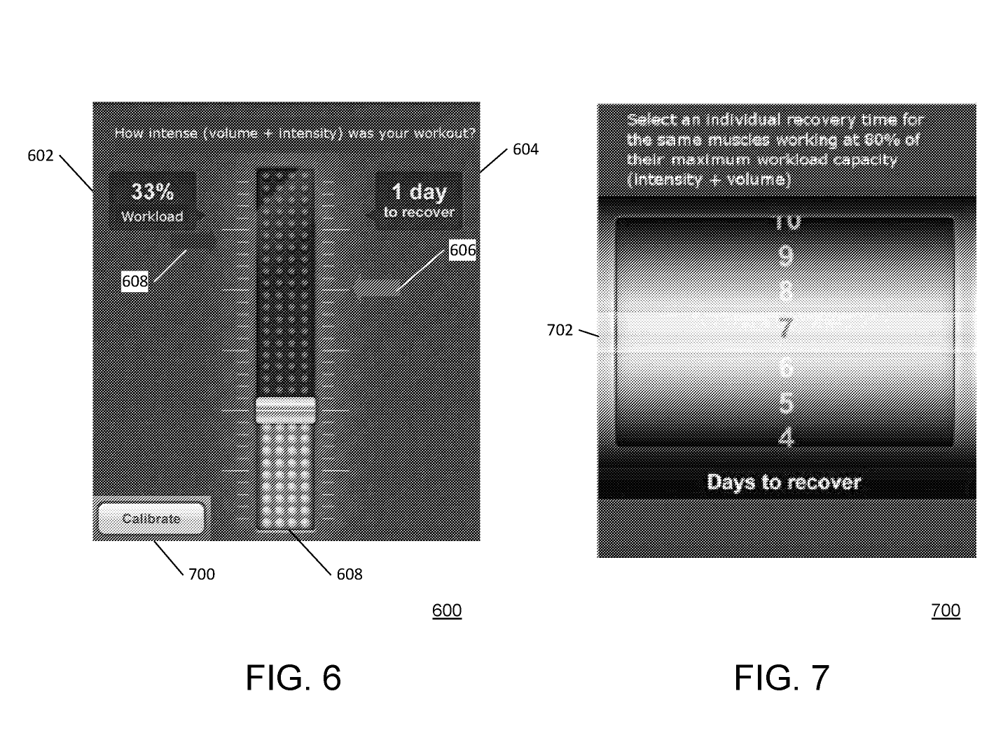

FIG. 6 is an illustrative view of a workload screen 600. In FIG. 6, the user can analyze a workload by using a slider bar 608 on the screen 600. The slider 608 can be used to indicate the total workload of a recent workout (e.g., combination of overall intensity and volume of a workout). By default, the recovery profile via step 210 can include the recovery profiles of steps 212 and 214. The recovery profile via step 212 can be used for recreational users, with default recovery times, for example, at 80% of the total workload, preset to 7 days. The recovery profile via step 214 can be used for athletes, with default recovery times, for example, at 80% of the total workload, preset to 5 days. This is because athletes typically can put in more of an effort for a fast recovery, including better nutrition, better living conditions, lower overall stress, and the like, as compared to recreational users.

Advantageously, by using health and fitness regime system 100, the user can begin to learn the limits of their body, proper workout intensity (e.g., via workload screen 600), optimal recovery (e.g., supercompensation) times for new workouts, and the like. As previously described with respect the three stages of the muscle recovery process, the same logic and similar features are applicable to the slider 608.

In addition, the workload screen 600 can be interpreted via various methods. For example, the screen 600 can be used for assisting the user in entering an individual recovery time via element 604, and a workload via element 602, for example, based on a total workload of a workout, and the like. This can be a subjective feeling of a recent workout, as the user begins to better learn the limits their body. The screen 600 also can be used based on the color codes (e.g., muscle soreness a couple of days after working out, including Delayed Onset Muscle Soreness (DOMS), etc.) indicated on the slider 608. For example, a bright color (e.g., on one third of the slider at the lower end), such as green, can be used to indicate light resistance, with no muscle soreness after the workout, and which can result in minimal or zero recovery times. An intermediate color (e.g., one third of the slider at the middle of the slider 608), such as yellow, can be used to indicate medium resistance, with one or two days of muscle soreness after the workout, and which can result in intermediate recovery times. A dark color (e.g., on one third of the slider at the upper end of the slider 608), such as red, can be used to indicates heavy resistance, with at least two days of muscle soreness after the workout, and which can result in high recovery times.

In addition, the elements 606-608 can be used to display advantageous guidance for the user, such as information for determining a threshold for a proper workout intensity (e.g., providing guidance for progressive overload or periodization techniques, etc.), information for determining optimal target intensity (e.g., volume plus intensity) of a workout, information about recent workout and its intensity, and the like. The elements 606-608 further can teach the user to learn their individual recovery times and to reach various states, such as supercompensation, hypertrophy, muscle adaptation, and the like. The user can manage the indication elements 606-608 via settings step 229. The described features of color coding and striping for color vision deficiency supported, and the like, the displaying of recovery information, and the like, also can be applied to the fine tuning screen 800, the recent workouts screen 900, the muscle recovery process screen 300, and the like.

FIG. 7 is an illustrative view of a calibrate screen 700. The calibrate screen 700 can be used for tailoring individual recovery times, as the user learns the limits of their body. In FIG. 7, the calibrate screen 700 enables the user to customize individual recovery times for the slider 608. For example, a set point for a calibration can be 80% level of a total workload of a workout. This can be an approximate level for an optimal workload, ranging from 60 to 85%, for example, based on suggestions from personal trainers, researchers, and the like. The recovery times on the slider 608 and 806 can begin on a percentage level of 33%, indicating one day of recovery. The set point for the 80% level can be calibrated for an individual, such as ranging from 2 days of recovery to 14 days. For example, an algorithm for calculating recovery times can be based on linear, and the like, functions, starting from a 33 percent point, and having lines for a each given calibration set point (e.g., ranging from 2 to 14 days) at the point of 80 percentage (e.g., 80% total workload of a workout).

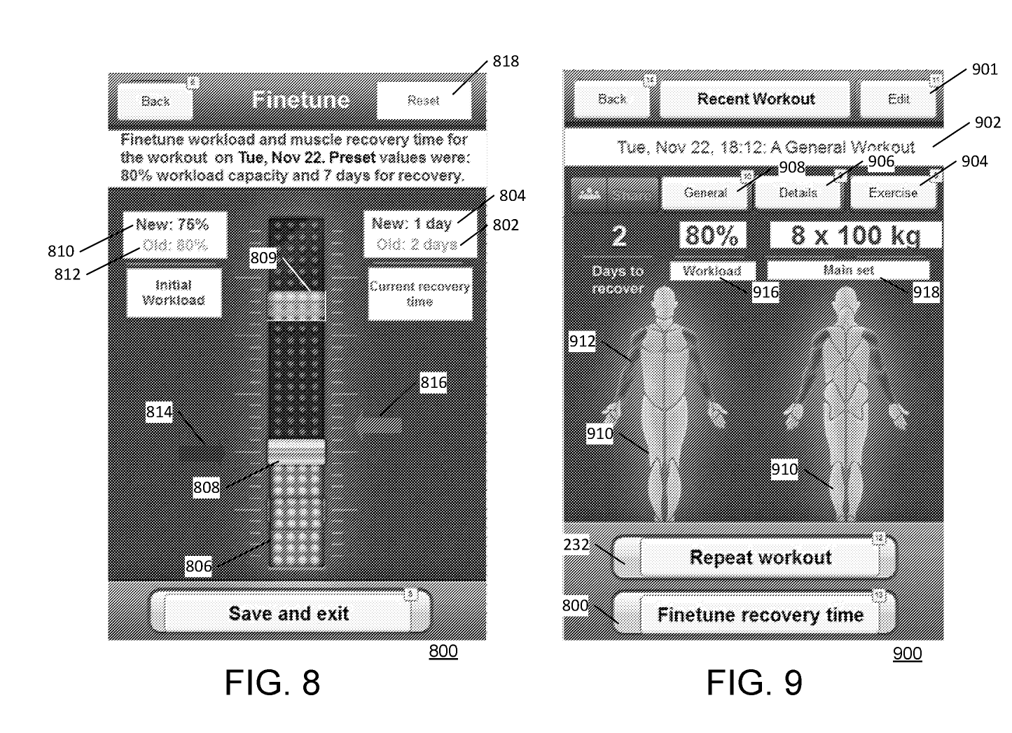

FIG. 8 is an illustrative view of a fine tuning screen 800. In FIG. 8, the fine tuning feature enable the user to readjust a current recovery value, initially submitted in the screen 600, for example, if the user feels that their muscle recovery status is not in the line with the muscle recovery process shown in the screen 300. The fine tuning capability can be further accessed via the recent workouts screen 900. For example, the user can access the fine tuning screen 800 as long as a particular workout is accessible in the recent workouts screen 900. The need for a fine tuning can occur during the next few days (e.g., 1 to 7 days or even more) after a particular workout. The interactive display screen 800 helps the user to learn to listen to their body, and achieve and learn proper recovery times, and the like.

As previously describe, the slider 808 can include the various features previously described with respect to the other sliders, and the like. This is due to the fine tuning screen 800 being based on the similar recovery logic as described with respect to the interactive display screen 600. For example, the initial or preset workload and recovery times can be displayed in the header section. The user can fine tune the current recovery times by adjusting the slider 808. The slider 808 can be used for illustrating the real time recovery process of a muscle or muscle group and the current status of the muscle recovery process screen 300. Thus, the position of the slider 808 can be time and day dependant in accordance with the muscle recovery process screen 300.

A translucent slider 809 can be provided for indicating the original state of the slider 808 during the moment of a particular workout. After the slider 808 is moved, new recovery times 804, old recovery times 802, and corrected workload values 810-812 are displayed for the user. In addition, the position of new workload is displayed for the user via the translucent slider 809. The elements 814-816 can be color coded and provide the user, for example, with information and suggestions about the correct recovery threshold, previous workouts, as previously described, and the like. The displayed information can be adjusted via the settings step 229.

Advantageously, the fine tuning capability of the screen 800, which the user can enter via the recent workout screen 900, helps the user to learn to listen to their body, to make post workout corrections for given workout information, and the like. In addition, the fine tuning capability of the screen 800 can be used to provide the user with relevant information via the various elements, for example, in cases where the user is reluctant to perform calibration via the screen 700. For example, such features can be provided via the elements 814-816 and 606-608 or by text or voice messages via the screens 300, 600, 700, 800 or 900, and the like. In addition, the user can revert back to previously stored or default values by pressing a reset button 818. The corrected or updated information can be stored in the database 236 and the user can access such information via the muscle recovery process screen 300, the data analyzer 102, the recent workouts screen 900, and the like.

FIG. 9 is an illustrative view of a recent workout screen 900. In FIG. 9, via element 912, the screen 900 can be used to display information regarding a real time muscle recovery process, after a physical exercise, divided into separate recent workouts, and depending on the user actions in the workout builder screen 400. The recent workout screen 900 enables the user to access workout based information of a certain workout, repeat a recent workout via step 232, fine tune muscle recovery times via the information screen 800 for specific muscles displayed via element 912.

The ability to repeat a recent workout is possible on the screen 900, even if the muscle recovery process at step 912 is not fully complete (e.g., for CrossFit, MMA applications, etc.). This is due to the muscle recovery status of element 912 being at a same stage for given muscle or muscle groups on the recent workout screen 900. Advantageously, this feature allows users to repeat a recent workout, without the need to first fine tune recovery times via the information screen 800. If such a case is occurring frequently, the fitness regime system 100 can prompt the user to use the calibration screen 700 for calibrating their individual recovery times. Such prompts can be displayed to the user, for example, via the elements 814-816 and 608-606 or via text or voice messages via the screens 300, 600, 700, 800 or 900, and the like.

In addition, the muscle recovery element 912 can include support for color vision deficiency, by being presented with preset colors and/or patterns of stripes, as previously described. For example, the muscle recovery process 912 can include the color coding and striping described with respect to elements 302, 304 and 306, for illustrating the different stages of the muscle recovery process. Muscles or muscle groups not related to a particular workout can defined as passive via element 910, and such muscles can be described on their related screens (e.g., the recent workout screens).

The screen 900 also can be used for displaying the date, time and name for a particular exercise, and the like, via information element 902. In addition, further information regarding a recent workout can be displayed via general information element 908 and detailed information element 906. An exercise button 904 is provided for changing the title and exercise information of a title element 902, and exercise parameter 918, for example, if exercise details are entered via step 248. A button 901 is provided for allowing the user to edit the recent workout screen 900, for example, by adding, editing or deleting workout related information, and the like.

The illustrative values, related to health and fitness regime system 100 can be temporarily stored in the recent workouts screen 900. On the screen 900, the user can repeat recent workouts or fine tune recovery times, and the like. The illustrative values, related to health and fitness regime system 100 can be permanently stored into database 236.

The data analyzer 102 is a user interface for displaying health and fitness related data to the user. The data analyzer 102 displays intuitive summaries and graphs from body parameters (e.g., stress, nutrition, sleep), muscles, workouts and individual exercises. Displayed information also can include preset and realized recovery times for each body muscle and exercise, which enables the data analyzer 102 to teach the user to learn balanced health and fitness regime by optimizing proper recovery (e.g., supercompensation) times. For example, recovery times and other values for muscles or individual exercises can be displayed for the user as a preset mode (e.g., initially submitted via element 608 or fine tuned via the screen 800), as a realized mode (e.g., the realized recovery time), and with median or average values, and the like.

The user can analyze advantageous conditions and historical data of their best workouts and cross tabulate the stored parameters in the database 236 via the data analyzer 102, including comparing repetition maximums (e.g., 1RM, 3RM, 5RM, 10RM, Custom RM) with recovery times, workload, stress, sleep, nutrition, and the like, thus learning the best possible body parameters and states for achieving supercompensation, muscle hypertrophy and adaptation, and the like.

Advantageously, the processes performed by the screens 300, 400, 600, 800, 900 and the data analyzer 102 can be used for continuously teaching the user to learn to listen to their body, thus learning individual recovery (e.g., supercompensation) times, and the like. Moreover, the data analyzer 102 can be used for teaching the user to optimize the state known as muscle adaptation and to avoid the state known as plateau, by providing monitoring, listing and an alarm system for workouts and workout routine methods. For example, with a one view, the user can see a full list of their recent workout routines. Chronological lists can be used for displaying individual names for workout routine methods and their duration (e.g., typically displayed for the user in weeks or in days).

Graphs and summaries generated by the data analyzer 102 can enable the user to cross tabulate important body and workout related parameters through intuitive views. For example, the user can see long term progress of recovery times (e.g., both preset and realized recovery times) and analyze this against other parameters, such as workload, stress, sleep, nutrition or exercise related achievements, such as volume, one, three, five, ten or custom repetition maximum, and the like. Advantageously, this helps the user to learn and achieve proper recovery times. Moreover, the data analyzer 102 helps the user to analyze and optimize methods for training techniques, such as progressive overload or periodization among other training techniques, by enabling the user to monitor continual results of workouts (e.g., both general and individually named exercises) and by helping the user to sustain the states known as muscle adaptation and hypertrophy and by avoiding the state known as plateau.

The above-described devices and subsystems of the health and fitness regime described in FIGS. 1-9 can include, for example, any suitable servers, workstations, PCs, laptop computers, PDAs, Internet appliances, handheld devices, cellular telephones, wireless devices, other devices, etc., capable of performing the processes of the described embodiments. The devices and subsystems can communicate with each other using any suitable protocol and can be implemented using any computer systems available.

It is to be understood that the health and fitness regime described in FIGS. 1-9 is for illustrative purposes, as many variations of the specific hardware used to implement the described embodiments are possible, as will be appreciated by those skilled in the relevant art(s). For example, the functionality of the devices and the subsystems of the health and fitness regime described in FIGS. 1-9 can be implemented via one or more programmed computer systems or devices.

To implement such variations as well as other variations, a single computer system can be programmed to perform the special purpose functions of one or more of the devices and subsystems of the health and fitness regime described in FIGS. 1-9. On the other hand, two or more programmed computer systems or devices can be substituted for any one of the devices and subsystems of the health and fitness regime described in FIGS. 1-9. Accordingly, principles and advantages of distributed processing, such as redundancy, replication, etc., also can be implemented, as desired, to increase the robustness and performance of the health and fitness regime described in FIGS. 1-9, for example.

The health and fitness regime described in FIGS. 1-9 can store information relating to various processes described herein. This information can be stored in one or more memories, such as a hard disk, optical disk, magneto-optical disk, RAM, etc., of the devices of the health and fitness regime described in FIGS. 1-9. One or more databases of the devices and subsystems of the health and fitness regime described in FIGS. 1-9 can store the information used to implement the embodiments of the present invention. The databases can be organized using data structures (e.g., records, tables, arrays, fields, graphs, trees, and/or lists) included in one or more memories, such as the memories listed above or any of the storage devices described in FIGS. 1-9, for example.

The previously described processes can include appropriate data structures for storing data collected and/or generated by the processes of the health and fitness regime described in FIGS. 1-9 in one or more databases thereof. Such data structures accordingly can include fields for storing such collected and/or generated data. In a database management system, data can be stored in one or more data containers, each container including records, and the data within each record can be organized into one or more fields. In relational database systems, the data containers can be referred to as tables, the records can be referred to as rows, and the fields can be referred to as columns. In object-oriented databases, the data containers can be referred to as object classes, the records can be referred to as objects, and the fields can be referred to as attributes. Other database architectures can be employed and use other terminology. Systems that implement the embodiments of the present invention are not limited to any particular type of data container or database architecture.

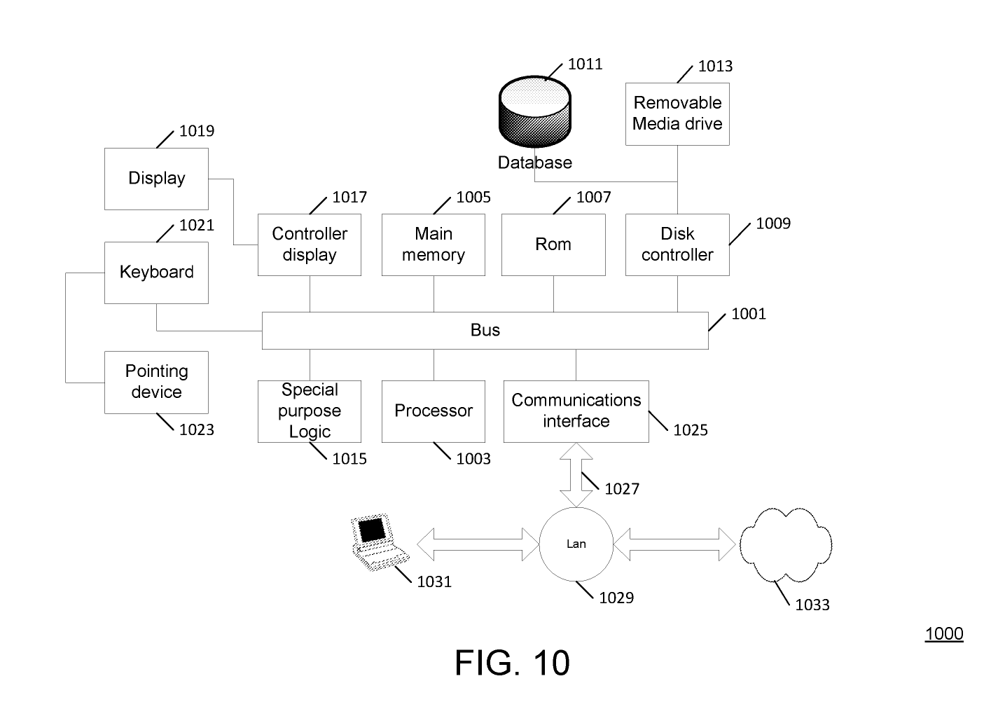

All or a portion of the health and fitness regime described with respect to FIGS. 1-9 can be conveniently implemented using one or more conventional general purpose computer systems, microprocessors, digital signal processors, micro-controllers, etc., programmed according to the teachings of the embodiments of the present invention (e.g., using the computer system of FIG. 10), as will be appreciated by those skilled in the computer and software art(s). Appropriate software can be readily prepared by programmers of ordinary skill based on the teachings of the present disclosure, as will be appreciated by those skilled in the software art. Further, the health and fitness regime described in FIGS. 1-9 can be implemented on the World Wide Web (e.g., using the computer system of FIG. 10). In addition, the health and fitness regime described in FIGS. 1-9 can be implemented by the preparation of application-specific integrated circuits or by interconnecting an appropriate network of conventional component circuits, as will be appreciated by those skilled in the electrical art(s).

FIG. 10 illustrates a computer system 1000 upon which the described embodiments (e.g., the devices and subsystems of the illustrative embodiments of FIGS. 1-9) can be implemented. The various embodiments can be implemented on a single such computer system, or a collection of multiple such computer systems. The computer system 1000 can include a bus 1001 or other communication mechanism for communicating information, and a processor 1003 coupled to the bus 1001 for processing the information. The computer system 1000 also can include a main memory 1005, such as a random access memory (RAM), other dynamic storage device (e.g., dynamic RAM (DRAM), static RAM (SRAM), synchronous DRAM (SDRAM)), etc., coupled to the bus 1001 for storing information and instructions to be executed by the processor 1003.

In addition, the main memory 1005 also can be used for storing temporary variables or other intermediate information during the execution of instructions by the processor 1003. The computer system 1000 further can include a ROM 1007 or other static storage device (e.g., programmable ROM (PROM), erasable PROM (EPROM), electrically erasable PROM (EEPROM), etc.) coupled to the bus 1001 for storing static information and instructions.

The computer system 1000 also can include a disk controller 1009 coupled to the bus 1001 to control one or more storage devices for storing information and instructions, such as a magnetic hard disk 1011, and a removable media drive 1013 (e.g., floppy disk drive, read-only compact disc drive, read/write compact disc drive, compact disc jukebox, tape drive, and removable magneto-optical drive). The storage devices can be added to the computer system 900 using an appropriate device interface (e.g., small computer system interface (SCSI), integrated device electronics (IDE), enhanced-IDE (E-IDE), direct memory access (DMA), or ultra-DMA).

The computer system 1000 also can include special purpose logic devices 1015, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, communications functions, etc.

The computer system 1000 also can include a display controller 1017 coupled to the bus 1001 to control a display 1019, such as a cathode ray tube (CRT), liquid crystal display (LCD), active matrix display, plasma display, touch display, etc., for displaying or conveying information to a computer user. The computer system can include input devices, such as a keyboard 1021 including alphanumeric and other keys and a pointing device 1023, for interacting with a computer user and providing information to the processor 1003. The pointing device 1023 can include, for example, a mouse, a trackball, a pointing stick, etc., or voice recognition processor, etc., for communicating direction information and command selections to the processor 1003 and for controlling cursor movement on the display 1019. In addition, a printer can provide printed listings of the data structures/information of the health and fitness regime described with respect to FIGS. 1-9, or any other data stored and/or generated thereby.

The computer system 1000 can perform a portion or all of the processing steps of the invention in response to the processor 1003 executing one or more sequences of one or more instructions contained in a memory, such as the main memory 1005. Such instructions can be read into the main memory 1005 from another computer readable medium, such as the hard disk 1011 or the removable media drive 1013. Execution of the arrangement of instructions contained in the main memory 1005 causes the processor 1003 to perform the process steps described herein. One or more processors in a multi-processing arrangement also can be employed to execute the sequences of instructions contained in the main memory 1005. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 1000, for driving a device or devices for implementing the invention, and for enabling the computer system 1000 to interact with a human user (e.g., users of the health and fitness regime system 100, etc.). Such software can include, but is not limited to, device drivers, firmware, operating systems, development tools, applications software, etc. Such computer readable media further can include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 1000 also can include a communication interface 1025 coupled to the bus 1001. The communication interface 1025 can provide a two-way data communication coupling to a network link 1027 that is connected to, for example, a local area network (LAN) 1029, or to another communications network 1033 (e.g. a wide area network (WAN), a global packet data communication network, such as the Internet, etc.). For example, the communication interface 1025 can include a digital subscriber line (DSL) card or modem, an integrated services digital network (ISDN) card, a cable modem, a telephone modem, etc., to provide a data communication connection to a corresponding type of telephone line. As another example, the communication interface 1025 can include a local area network (LAN) card (e.g., for Ethernet™, an Asynchronous Transfer Model (ATM) network, etc.), etc., to provide a data communication connection to a compatible LAN. Wireless links can also be implemented. In any such implementation, the communication interface 1025 can send and receive electrical, electromagnetic, or optical signals that carry digital data streams representing various types of information. Further, the communication interface 1025 can include peripheral interface devices, such as a Universal Serial Bus (USB) interface, a PCMCIA (Personal Computer Memory Card International Association) interface, etc.

The network link 1027 typically can provide data communication through one or more networks to other data devices. For example, the network link 1027 can provide a connection through the LAN 1029 to a host computer 1031, which has connectivity to the network 1033 or to data equipment operated by a service provider. The LAN 1029 and the network 1033 both can employ electrical, electromagnetic, or optical signals to convey information and instructions. The signals through the various networks and the signals on the network link 1027 and through the communication interface 1025, which communicate digital data with computer system 1000, are illustrative forms of carrier waves bearing the information and instructions.

The computer system 1000 can send messages and receive data, including program code, through the network 1029 and/or 1033, the network link 1027, and the communication interface 1025. In the Internet example, a server can transmit requested code belonging to an application program for implementing an embodiment of the present invention through the network 1033, the LAN 1029 and the communication interface 1025. The processor 1003 can execute the transmitted code while being received and/or store the code in the storage devices 1011 or 1013, or other non-volatile storage for later execution. In this manner, computer system 1000 can obtain application code in the form of a carrier wave. With the system of FIG. 10, the embodiments of the present invention can be implemented on the Internet as a Web Server 1000 performing one or more of the processes according to the embodiments of the present invention for one or more computers coupled to the web server 1000 through the network 1033 coupled to the network link 1027.

The term “computer readable medium” as used herein can refer to any medium that participates in providing instructions to the processor 1003 for execution. Such a medium can take many forms, including but not limited to, non-volatile media, volatile media, transmission media, etc. Non-volatile media can include, for example, optical or magnetic disks, magneto-optical disks, etc., such as the hard disk 1011 or the removable media drive 1013. Volatile media can include dynamic memory, etc., such as the main memory 1005. Transmission media can include coaxial cables, copper wire and fiber optics, including the wires that make up the bus 1001. Transmission media can also take the form of acoustic, optical, or electromagnetic waves, such as those generated during radio frequency (RF) and infrared (IR) data communications.

As stated above, the computer system 1000 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to either of the networks 1029 and 1033. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

Thus, the health and fitness regime described with respect to FIGS. 1-10 provides a cost effective method and system for gaining balanced health and fitness regime, including receiving information regarding to recovery times of workouts; receiving other workout related information; enabling users to learn their individual recovery times; enabling users to reach the state known as supercompensation; enabling users to see current muscle recovery process; enabling users to optimize the state known as muscle adaptation; and enabling users to avoid the state known as plateau; inputting recovery times, including capability for individual calibration; enabling users to reach the state known as hypertrophy, fine tuning preset recovery times; analyzing preset and realized recovery times; enabling users to learn proper workout intensity, resistance; and the like.

Although the illustrative embodiments are described in terms of health and fitness regime system and client, the present invention can be implemented as a server and related modules included within the health and fitness regime program, as will be appreciated by those skilled in the relevant art(s).

Although the illustrative embodiments are described in terms of health and fitness regime system and client, the present invention can be implemented as a part of a user interface for conventional exercise equipment, exercise machines, and the like, as will be appreciated by those skilled in the relevant art(s).

While the present invention have been described in connection with a number of illustrative embodiments and implementations, the present invention is not so limited but rather covers various modifications and equivalent arrangements, which fall within the purview of the appended claims.

1. A system for gaining a balanced health and fitness regime, comprising:
a user interface configured for receiving and displaying information regarding muscle recovery times of workouts of a user; and
the user interface is configured in a form of a human body with selectable muscle portions thereon for displaying respective information regarding the recovery times of the workouts of a user.

2. The system of claim 1, further comprising:
the user interface configured for receiving workout related information from the user;
the user interface configured for enabling the user to learn workout recovery times, including microcycles and mesocycles;
the user interface configured for enabling the user to reach a hypertrophy state;
the user interface configured for enabling the user to see a muscle recovery process;
the user interface configured for enabling the user to optimize a muscle adaptation state; and
the user interface configured for enabling the user to avoid a plateau state.

3. The system of claim 1, further comprising:
the user interface configured for enabling the user to input recovery times, including a capability for individual calibration, enabling the user to reach a supercompensation state and avoid symptoms of overtraining.

4. The system of claim 1, further comprising:
the user interface configured for enabling the user to fine tune recovery times;
the user interface configured for enabling the user to analyze preset and realized recovery times; and
the user interface configured for enabling the user to compare recovery times with workout related information.

5. The system of claim 1, further comprising:
the user interface configured for analyzing a workout workload, including workout intensity and workout volume of a workout.

6. A method for gaining a balanced health and fitness regime, comprising:
providing a user interface configured for receiving and displaying information regarding muscle recovery times of workouts of a user; and
wherein the user interface is configured in a form of a human body with selectable muscle portions thereon for displaying respective information regarding the recovery times of the workouts of a user.

7. A computer program product for gaining a balanced health and fitness regime including one or more computer readable instructions embedded on a tangible, non-transitory computer and configured to cause one or more computer processors to perform the steps of:
providing a user interface configured for receiving and displaying information regarding muscle recovery times of workouts of a user; and
wherein the user interface is configured in a form of a human body with selectable muscle portions thereon for displaying respective information regarding the recovery times of the workouts of a user.

8. The method of claim 6, wherein the user interface is configured for receiving workout related information from the user;
the user interface is configured for enabling the user to learn workout recovery times, including microcycles and mesocycles;
the user interface is configured for enabling the user to reach a hypertrophy state;
the user interface is configured for enabling the user to see a muscle recovery process;
the user interface is configured for enabling the user to optimize a muscle adaptation state; and
the user interface is configured for enabling the user to avoid a plateau state.

9. The method of claim 6, wherein the user interface is configured for enabling the user to input recovery times, including a capability for individual calibration, enabling the user to reach a supercompensation state and avoid symptoms of overtraining.

10. The method of claim 6, wherein the user interface is configured for enabling the user to fine tune recovery times;
the user interface is configured for enabling the user to analyze preset and realized recovery times; and
the user interface is configured for enabling the user to compare recovery times with workout related information.

11. The method of claim 6, wherein the user interface configured for analyzing a workout workload, including workout intensity and workout volume of a workout.

12. The computer program product of claim 7, wherein the user interface is configured for receiving workout related information from the user;
the user interface is configured for enabling the user to learn workout recovery times, including microcycles and mesocycles;
the user interface is configured for enabling the user to reach a hypertrophy state;
the user interface is configured for enabling the user to see a muscle recovery process;
the user interface is configured for enabling the user to optimize a muscle adaptation state; and
the user interface is configured for enabling the user to avoid a plateau state.

13. The computer program product of claim 7, wherein the user interface is configured for enabling the user to input recovery times, including a capability for individual calibration, enabling the user to reach a supercompensation state and avoid symptoms of overtraining.

14. The computer program product of claim 7, wherein the user interface is configured for enabling the user to fine tune recovery times;
the user interface is configured for enabling the user to analyze preset and realized recovery times; and
the user interface is configured for enabling the user to compare recovery times with workout related information.

15. The computer program product of claim 7, wherein the user interface configured for analyzing a workout workload, including workout intensity and workout volume of a workout.
